(19) United States
(12) Patent Application Publication
(10) Pub. No.: US 2015/0354394 A1
(43) Pub. Date: Dec. 10, 2015

(54) SHROUD ABRADABLE COATINGS AND METHODS OF MANUFACTURING

(71) Applicant: General Electric Company, Schenectady, NY (US)

(72) Inventor: Luc Stephane LEBLANC, I, Clifton Park, NY (US)

(73) Assignee: General Electric Company, Schenectady, NY (US)

(21) Appl. No.: 14/587,744

(22) Filed: Dec. 31, 2014

Related U.S. Application Data
(63) Continuation-in-part of application No. 14/300,520, filed on Jun. 10, 2014.
Application No. 14/300,520 is a continuation-in-part of application No. 14/300,666, filed on Jun. 10, 2014.

(51) Int. Cl. F01D 11/12; C23C 4/12; C23C 4/18; C23C 4/10

(52) U.S. Cl. CPC F01D 11/122; C23C 4/105; C23C 4/12; C23C 4/18; F05D 2220/30; F05D 2230/90; F05D 2300/211; F05D 2300/2118; F05D 2300/611

(57) ABSTRACT

Methods of manufacturing turbine shrouds with an abradable coating that balance the apparently contradictory requirements of high flowpath solidity, low blade tip wear, and good durability in service may include forming an abradable coating on a surface of a coating system to form a substantially smooth flowpath surface. Forming the abradable coating includes forming a relatively porous, smooth abradable coating. The methods may also include machining the abradable so as to achieve a substantially smooth flowpath surface.

### BACKGROUND

The present technology generally relates to high temperature abradable coatings and to methods of manufacturing high temperature abradable coatings, in particular to turbine shrouds with high temperature abradable coatings.

Materials which abrade relatively readily may be used to form seals between a rotating component (rotor) and a fixed component (stator). Typically, the rotor wears away a portion of a stator having the abradable material, so as to form a seal characterized by a relatively small gap between the rotor and stator. An application of abradable seals is in turbines (e.g., gas turbines), in which a rotor including a plurality of blades mounted on a shaft is surrounded by a stationary shroud. In the high pressure turbine (HPT) section, these shrouds define a hot gas flowpath in the turbine. Minimizing the clearance between the blade tips and the inner wall of the shroud reduces leakage of the hot gas around the blade tips leading to improved turbine efficiency.

To reduce blade tip wear, it is known to use patterned abradable architectures on the shroud flowpath surface. By reducing the solidity of the shroud surface in contact with the passing blade, the relative blade tip wear is reduced. While a patterned shroud surface may reduce blade wear, it can decrease turbine efficiency due to leakage losses over the passing blade tips. As a result, substantially smooth, continuous-flowpath surface abradable structures are desired to reduce leakage, while patterned abradable surfaces are desired to minimize blade tip wear. One approach to resolve this apparent contradiction of shroud flowpath surfaces has been to use highly porous abradable materials with a substantially smooth, continuous flowpath surface. However, such materials are found to be highly friable, suffering low durability under erosive and other harsh-environment conditions.

As a result, a need exists for methods of making abradable shrouds and resulting abradable shrouds that include an architecture and microstructure that balances the contradictory requirements of high flowpath solidity, low blade tip wear, and good durability in service.

### SUMMARY

According to one example of the present technology, a method of manufacturing a turbine shroud comprises forming a porous friable coating over a barrier coating system provided on a substrate of the turbine shroud to form a substantially smooth continuous flowpath surface.

According to another example of the present technology, a shroud for a turbine, comprises a substrate having an outer surface configured to be disposed adjacent tips of rotating turbine blades and at least partially defining an outer annulus of a turbine flowpath; a barrier coating system overlying at least a portion of the outer surface of the substrate; and a porous friable coating overlying at least a portion of the barrier coating system, the porous friable coating defining a substantially smooth continuous flowpath surface.

### BRIEF DESCRIPTION OF THE DRAWINGS

These and other objects, features and advantages of this disclosure will become apparent from the following detailed description of the various aspects of the disclosure taken in conjunction with the accompanying drawings.

FIG. 1 is a top view of an exemplary embodiment of a shroud having an abradable coating according to the present disclosure, showing a trace of passing turbine blades;

FIG. 2 is a cross-sectional view of a portion of an exemplary shroud according to the present disclosure;

FIG. 3 is a flowchart depicting an exemplary method of manufacturing an exemplary shroud with an abradable coating according to the present disclosure;

FIG. 4 is a flowchart depicting an exemplary method of manufacturing an exemplary shroud with an abradable coating according to the present disclosure;

FIG. 5 is a flowchart depicting an exemplary method of manufacturing an exemplary shroud with an abradable coating according to the present disclosure;

FIG. 6 is a flowchart depicting an exemplary method of manufacturing an exemplary shroud with an abradable coating according to the present disclosure; and

FIG. 7 is a cross-sectional view of a portion of another exemplary shroud according to the present disclosure.

### DETAILED DESCRIPTION

Approximating language as used herein throughout the specification and claims may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

As discussed above, conventional turbine shrouds include either a patterned surface or a substantially smooth surface configured to abrade when/if a turbine blade contacts the shroud. A substantially smooth abradable surface of a shroud maintains flowpath solidity but can result in severe blade tip wear. Patterned abradable shroud surfaces result in significantly reduced blade tip wear as compared to unpatterned or substantially smooth-flowpath shrouds, but allow leakage across the blade tip that leads to decreased turbine efficiency. The present technology provides shroud coatings, coated shrouds and methods of coating shrouds that include a hybrid architecture that balances the apparently contradictory requirements of high flowpath solidity, low blade tip wear, and high durability.

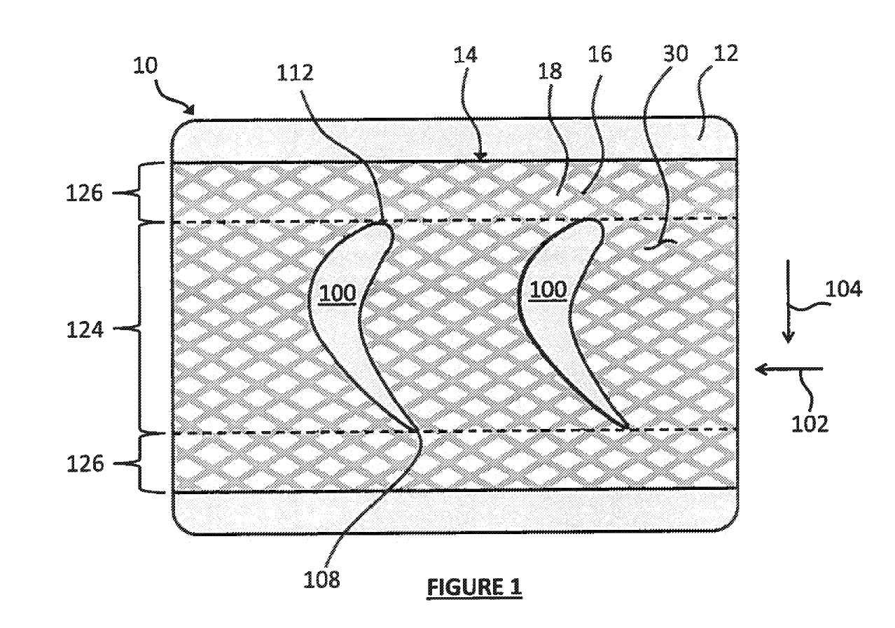

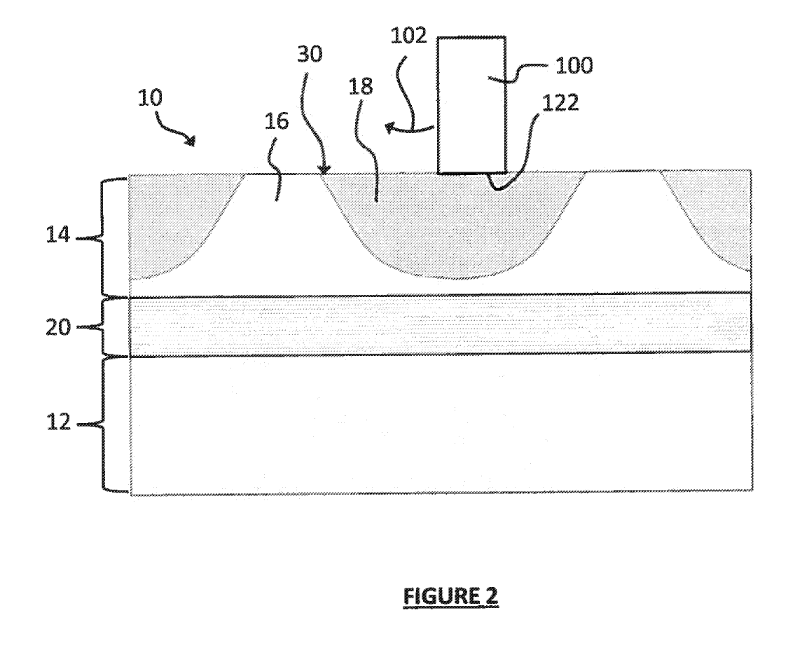

Referring to FIGS. 1 and 2, an abradable coated shroud structure 10 may include a substrate 12 and an abradable coating 14 having a hybrid architecture and overlying a portion of the substrate 12. The abradable coating 14 may overlie at least a portion of an inward-facing surface of the shroud 10 that, in use, is positioned adjacent the tips 122 of turbine blades 100. The shroud 10 may define, at least in part, a surface 30 of the hot gas flowpath through a particular portion of a turbine (i.e., the outer annulus of the turbine flowpath). To reduce leakage across the blade tips 122 (and increase efficiency of the turbine), the shroud 10 and blade tips 122 may be configured such that the blade tips 122 rub into the abradable coating 14 during turbine operation. The architecture of the abradable coating 14 is configured to wear during blade incursion such that a seal is created between the blade tips 122 and the abradable coating 14 of the shroud 10. The architecture of the abradable coating 14 of the shroud 10 is configured to form a substantially smooth flowpath surface 30, reduce blade wear during incursions, and provide a thermo-mechanically durable flowpath surface 30 during use in a turbine.

Referring to FIG. 2, the substrate 12 may include or be formed of a metal or metal alloy. The metal or metal alloy may be nickel-based and/or cobalt-based, such as a nickel-based or cobalt-based superalloy. The substrate 12 may include or be formed of a ceramic, such as a ceramic matrix composite (CMC) material. The ceramic and/or CMC substrate 12 may be a SiC/SiC composite and/or an oxide/oxide composite. As shown in FIG. 2, the substrate 12 may form an inner base upon which other components or materials may be applied or affixed to form the shroud structure 10. The substrate 12 may at least generally form the shape and size of the shroud structure 10. The substrate 12 may substantially provide the structural support of the shroud structure 10.

The shroud 10 may include a coating system 20 disposed over the substrate 12. The coating system 20 may comprise one or more component or material and may be positioned between the substrate 12 and the abradable coating 14. The coating system 20 may include a bondcoat, a barrier coating, or a bondocat and a barrier coating. For example, the substrate 12 may be metal, and the coating system 20 of the shroud 10 may include a thermal barrier coating (TBC) applied thereon. The TBC-based coating system 20 may contain one or more TBC layers. The one or more TBC layers may be zirconia-based. The one or more TBC layers of the coating system 20 may include yttria-stabilized zirconia (YSZ), such as zirconia containing 7-8 weight percent yttria. The one or more TBC layers of the coating system 20 may include fully stabilized zirconia (FSZ).

The substrate 12 may be a ceramic, and the coating system 20 may include an environmental barrier coating (EBC) applied thereon. The EBC-based coating system 20 may contain one or more EBC layers. The one or more EBC layers of the coating system 20 may be silicate-based. The one or more EBC layers of the coating system 20 may include one or more rare earth silicates, such as RE₂Si₂O₇ and/or RE₂SiO₅, where RE comprises one or more of Y, Er, Yb, and Lu.

The coating system 20 may include a bondcoat overlying the substrate 12. The coating system 20 may include an EBC or TBC coating applied over the bond coat. The bond coat may provide oxidation resistance to the substrate 12 and/or to assist in maintaining adherence of the EBC/TBC coating. The shroud 10 may include a TBC-coated metallic substrate 12, and the coating system 20 may include a bond coat between the substrate 12 and the TBC coating including a NiAl, (Pt,Ni)Al, or (Ni,Co)CrAlY type of composition. The shroud 10 may include an EBC-coated ceramic substrate 12, and the coating system 20 may include a Si-based bond coat between the substrate 12 and the EBC coating.

As shown in FIGS. 1 and 2 and as discussed above, the shroud 10 may include an abradable coating 14 overlying at least a portion of the shroud 10, such as over an outer surface of a coating system 20 on the shroud 10 (e.g., an EBC/TBC-based coating system 20). The abradable coating 14 may define the flowpath surface 30 of the shroud 10 such that the flowpath surface 30 faces the centerline of the turbine when the shroud 10 and rotor are assembled. For example, as shown in FIGS. 1 and 2, the abradable coating 14 may form the flowpath surface 30 of the shroud 10 such that it faces or is directed toward, at least generally, rotating turbine blades 100 having tips 122 passing across the flowpath surface 30 of the shroud 10. The blades 100 may abrade, wear, or otherwise remove portions of the abradable coating 14 along a blade track 124 as the turbine blades 100 pass over and through the abradable coating 14 provided on shroud 10. Incursion of the turbine blade tips 122 within the abradable coating 14 may form wear track 124 within the abradable coating 14 during contact therewith, as shown in FIG. 1. Arrow 102 in FIG. 1 indicates a direction of translation of the turbine blade 100 with respect to the abradable coating 14 as results from a rotation of the turbine rotor, as described above. Arrow 104 in FIG. 1 indicates the axial direction of a fluid flow with respect to the abradable coating 14 and blades 100. The turbine blade tips 122 may include a leading edge 112 and a trailing edge 108 that define the boundaries of the wear track 124 as indicated by the dashed lines in FIG. 1. The wear track 124 may include only a portion of the abradable coating 14 such that at least one non-abraded portion 126 of the abradable coating 14 positioned outside the boundaries of the wear track 124 may remain unworn. As described further below, the abradable coating 14 may further include first regions 16 corralling second regions 18, such that the blade track 124 extends across the first and second regions 16, 18.

The thickness of the abradable coating 14 as measured from the outer-most surface of the coating system 20 to the flowpath surface 30 may be within the range of about 0.1 mm and about 2 mm, and more preferably within the range of about 0.2 mm and about 1.5 mm. The abradable coating 14 may be initially manufactured thicker than as described above, and machined or otherwise treated to achieve the thicknesses described above. For example, after forming or manufacturing the abradable coating 14 with the first and second regions 16, 18, the abradable coating 14 may be machined, polished, or otherwise treated by removing material from the abradable coating 14 so as to provide a desired clearance between the blade tips 122 and the flowpath surface 30. The treating of the abradable coating 14 from the as-manufactured condition to create the desired flowpath surface 30 may reduce the thickness of the abradable coating 14. The flowpath surface 30 may be substantially smooth. The flowpath surface 30 may include some curvature in the circumferential and/or axial directions. As another example, the substrate 12 may include curvature, and the curvature of the flowpath surface 30 may substantially conform to that of the substrate 12.

With reference to FIG. 2, the second regions 18 may be more intrinsically abradable than the first regions 16. For example, an abradable shroud coating including only the material of the second regions 18 may be more easily abraded by tips of rotating turbine blades as compared to an abradable shroud coating that includes the material of the first regions 16 in place of the material of the second regions 18. The first regions 16 may be a patterned structure or scaffold of relatively dense ridges or relative “high” portions that provide mechanical integrity while supporting blade tip 122 incursion without undue blade wear. The second regions 18 may include a highly friable microstructure that readily abrades in response to blade incursion while having relatively poor mechanical integrity as a stand-alone structure as compared to the first regions or scaffold 16. The highly friable microstructure of the second regions 18 can be achieved, for example, using a relatively porous and/or microcracked microstructure as compared to the first regions 16. As shown in FIGS. 1 and 2, the second regions 18 may be corralled by the relatively dense scaffold or first regions 16 to facilitate blade incursion while remaining substantially intact during typical turbine operation, including operation under typical erosive, gas loading and dynamic conditions. The first and second regions 16, 18 of the abradable coating 14 may together form a continuous, substantially smooth flowpath surface 30. The first and second regions 16, 18 of the abradable coating 14 may thereby form a thermo-mechanically robust abradable structure that balances the apparently contradictory requirements of high flowpath solidity, low blade tip wear, and high durability.

The second regions 18 may be less dense than the first regions 16. For example, the second regions 18 may include about 20% to about 65% porosity, while the first regions 16 may include less than about 20% porosity. The second regions 18 may include about 25% to about 50% porosity, while the first regions 16 may include less than about 15% porosity. Both the first and second regions 16, 18 of the abradable coating 14 may be capable of withstanding temperatures of at least about 1150° C., for example at least about 1300° C.

A method of manufacturing the second regions 18 of the abradable coating 14 may include use of one or more fugitive filler material to define the volume fraction, size, shape, orientation, and spatial distribution of the porosity. The filler material may include fugitive materials and/or pore inducers, such as but not limited to polystyrene, polyethylene, polyester, nylon, latex, walnut shells, inorganic salts, graphite, and combinations thereof. The filler material of the second regions 18 may act to decrease the in-use density of the second material. At least a portion of the filler material of the second regions 18 may be evaporated, pyrolized, dissolved, leached, or otherwise removed from the second regions 18 during the manufacturing process (such as subsequent heat treatments or chemical treatments or mechanical treatments) or during use of the shroud 10. The method of manufacturing the second regions 18 of the abradable coating 14 may include use of one or more sintering aids, such as to form lightly sintered powder agglomerates.

The first and second regions 16, 18 of the abradable coating 14 may include substantially the same composition or material. For example, the first and second regions 16, 18 of the abradable coating 14 may both substantially include stabilized zirconia (such as with metallic substrates) or rare earth silicates (such as with ceramic substrates). Both the first and second regions 16, 18 of the abradable coating 14 may substantially include stabilized zirconia, and the substrate 12 of the shroud 10 may be nickel-based and/or cobalt-based. Both the first and second regions 16, 18 of the abradable coating 14 may substantially include rare earth silicates, and the substrate 12 of the shroud 10 may be SiC-based and/or Mo—Si—B-based. The composition or material of the first and second regions 16, 18 may substantially differ. At least one of the first and second regions 16, 18 may substantially include, or be formed of, one or more materials of the underlying coating system 20 (e.g., an EBC/TBC and/or bond coat containing coating system 20).

As shown in FIG. 2, the second regions 18 may be substantially corralled by the first regions or scaffold 16 (i.e., positioned in-between or within the pattern of the scaffold 16). The first and second regions 16, 18 may be arranged or configured such that the passing turbine blades pass over and potentially rub into the flowpath surface 30, thereby removing both the first and second regions 16, 18 of the abradable coating 14 of the shrouds 10. In this way, the first regions or scaffold 16 may provide mechanical integrity to protect the substantially friable second regions 18 from being damaged during operation by, for example, erosion, while supporting blade tip 122 incursion without undue blade wear. The first and second regions 16, 18 of the abradable coating 14 of the shroud 10 may be arranged in any pattern, arrangement, orientation or the like such that the second regions 18 are positioned between (i.e., corralled by) the first regions 16, as illustrated in FIG. 2. The first and second regions 16, 18 of the abradable coating 14 may be arranged such that the denser first regions 16 effectively shield the more friable second regions 18 from erosive flux.

The first regions 16 of the abradable coating 14 of the shroud 10 may include or be defined by ridges extending from the coating system 20 to the flowpath surface 30. For example, as shown in FIG. 2, the first regions 16 of the abradable coating 14 may include periodic ridges that extend from the coating system 20. In some embodiments, adjacent ridges of the first regions 16 of the abradable coating 14 may be isolated from each other. In some other embodiments, as illustrated in FIG. 2, adjacent ridges of the first regions 16 of the abradable coating 14 may be contiguous via their bases. The ridges (and/or other portions of the first regions 16) may extend along a direction at least generally perpendicular to the direction of the passing turbine blades. The first regions 16 of the abradable coating 14 may extend along a path or shape that substantially matches the camberline of the turbine blades. The first region 16 of the abradable coating 14 comprises a set of substantially periodically spaced ridges arranged such that the direction of translation of the periodic ridges is substantially parallel to the blade passing direction 102. The ridges of the first region 16 may have portions that are non-parallel to each other, comprising patterned ridge architectures such as parallelograms, hexagons, circles, ellipses, or other open or closed shapes. Each first region or ridge 16 of the abradable coating 14 may be substantially equidistant from its adjacent first region or ridges 16. One or more first region or ridge 16 of the abradable coating 14 may be variably spaced from its adjacent first region or ridge 16.

At least one of the first and second regions 16, 18 of the abradable coating 14 of the shroud 10 may extend linearly, non-linearly (e.g., may include one or more curves, bends, or angles), may or may not intersect with each other, may form a regular or irregular pattern, or consist of combinations thereof or any other arrangement, pattern or orientation such that—during incursions—the turbine blades pass through the first and second regions 16, 18 of the abradable coating 14 and the first regions 16 corral the second regions 18.

Referring to FIG. 2, the first regions 16 include relatively thick ridges such that the thickness-averaged ridge solidity is about 30%. The first regions 16 may extend over the coating system 20, and the second regions 18 may extend substantially over valleys or relatively thin portions of the first regions 16. In this way, the second regions 18 may fill valleys of the first regions 16. The first regions 16 and the second regions 18 may extend from the coating system 20 to the flowpath surface 30 (not shown).

The center-to-center distance between adjacent ridges of the first regions 16 may be within the range of about 1 mm and 6 mm, for example within the range of about 2 mm and 5 mm. The solidity of first regions 16, defined as the fraction of the total surface area of the flowpath surface 30 comprised of first regions 16, may be within the range from about 2% to about 50%, and more preferably may be within the range from about 5% to about 20%.

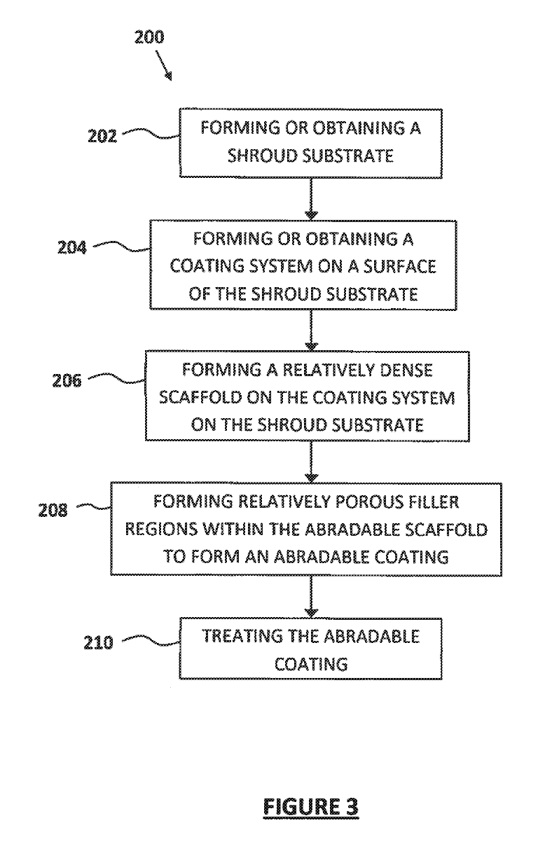

FIGS. 3-5 include flowcharts depicting methods 200, 300 and 400 of manufacturing a shroud with an abradable coating. The methods 200, 300 and 400 of manufacturing a shroud with an abradable coating may include one or more of the shrouds 10 and abradable coatings 14 described above in FIGS. 1 and 2 (including variations or alternative embodiments thereof). As such, FIGS. 1 and 2 and all of the description or disclosure herein with respect to the shrouds 10 and the abradable coatings 14, and related aspects, coatings, layers, features, dimensions, functions, arrangements and the like thereof (and alternatives, equivalents and modifications thereof) equally applies to the exemplary methods 200, 300 and 400 of manufacturing a shroud with an abradable coating of FIGS. 3-5 and may not be specifically discussed herein. The methods 200, 300 and 400 of manufacturing a shroud with an abradable coating of FIGS. 3-5 may be utilized to manufacture one or more shroud 10 with an abradable coating 14 with one or more aspects different than as discussed above with respect to FIGS. 1 and 2.

Referring to FIG. 3, a method 200 of manufacturing a shroud with an abradable coating may include forming or obtaining 202 a shroud substrate. Forming 202 a shroud substrate may include manufacturing or forming the shroud substrate 12, at least in part.

The method 200 may include forming or obtaining 204 a coating system on a surface of the shroud substrate 12. Forming or obtaining 204 the coating system on the surface of the shroud substrate may include forming or obtaining a TBC coating on at least one surface of the shroud substrate or forming or obtaining 204 an EBC coating on at least one surface of the shroud substrate.

Forming or obtaining 204 a coating system on an outer surface of the shroud substrate may include applying the coating system to at least a portion of an outer surface of the substrate by spraying, rolling, printing or otherwise mechanically and/or physically applying the coating system over at least a portion of a surface of the substrate. Forming or obtaining 204 a coating system on an outer surface of the shroud substrate may include treating as-applied coating system material to cure, dry, diffuse, sinter or otherwise sufficiently bond or couple the coating system to the substrate.

The method 200 may include forming 206 a relatively dense abradable scaffold on at least a portion of the shroud substrate, such as over the coating system 20 described above, including forming 206 the relatively dense abradable scaffolds or first regions 16.

In some embodiments forming 206 a relatively dense abradable scaffold on at least a portion of the shroud substrate includes forming a relatively dense, strong patterned structure that provides mechanical integrity to the abradable coating while having sufficiently low solidity so as to support blade tip incursion with minimal blade wear. Forming 206 a relatively dense abradable scaffold on at least a portion of the shroud substrate may be performed before forming 208 relatively porous friable filler regions that readily abrade in response to blade incursion within the scaffold to form a flowpath surface.

Forming 206 a relatively dense abradable scaffold on at least a portion of the shroud substrate may include at least one additive manufacturing method or technique, such as thermally spraying the relatively dense abradable material of the scaffold (e.g., the materials of the first region 16 discussed above) through a patterned mask to form the scaffold pattern or structure of the ridges of first regions 16. Forming 206 a relatively dense abradable scaffold on at least a portion of the shroud substrate may include direct-write thermal spraying the relatively dense abradable material in the form of a scaffold. The direct-write thermal spraying may include utilizing a small-footprint gun and dynamic aperture to form the scaffold. Forming 206 a relatively dense abradable scaffold on at least a portion of the shroud substrate may include dispensing a slurry paste in the form of a green scaffold pattern on the coating system, followed by heat treating the slurry paste so as to sinter it and form the relatively dense scaffold.

Forming 206 a relatively dense abradable scaffold on at least a portion of the shroud substrate may include applying a continuous blanket layer of relatively dense abradable material, followed by removal of portions of the blanket layer to selectively define the scaffold or pattern of the relatively dense abradable material. Removal of portions of the blanket layer to selectively define the scaffold or pattern may include machining portions of the blanket layer to selectively define the scaffold or pattern may be performed utilizing a mill, water jet, laser, abrasive grit blaster, or combinations thereof to remove portions of the blanket layer of relatively dense abradable material.

Forming 206 a relatively dense abradable scaffold on at least a portion of the shroud substrate may include screen printing, slurry spraying or patterned tape-casting ceramic powder with binder and, potentially, one or more sintering aid, so as to form a green scaffold or pattern which, upon sintering, forms a relatively dense abradable material (e.g., the materials of the first regions 16 discussed above).

Forming 208 relatively porous friable filler regions between the dense abradable scaffold may include back-filling, depositing or otherwise applying relatively porous friable filler regions (e.g., the materials of the second regions 18 discussed above) in-between the relatively dense abradable scaffold.

Forming or obtaining 208 relatively porous friable filler regions in-between the dense abradable scaffold may include applying relatively porous friable filler material by thermal spray (with or without a mask) in-between the relatively dense abradable scaffold or pattern. The relatively porous friable filler material may be ceramic powder having the composition of the first regions 16 discussed above. The ceramic powder may include at least one additive, such as a fugitive filler material, pore inducer, and/or sintering aid (as discussed above), such that the at least one additive is co-deposited, such as via thermal spray, with the ceramic powder.

Forming 208 relatively porous friable filler regions in-between the dense abradable scaffold may include applying relatively porous friable filler material as a slurry. The slurry formulation may be a ceramic slurry formulation and include at least one additive, such as a fugitive filler material, pore inducer, and/or sintering aid such that the at least one additive is co-deposited with the ceramic slurry formulation. Forming 208 relatively porous friable filler regions in-between the dense abradable scaffold may include applying a relatively porous friable filler by tape-casting or screen printing. The particle size distribution of the particles of the slurry is selected to provide a highly porous microstructure having coarse particles partially sintered at contact points. Forming 208 relatively porous friable filler regions in-between the dense abradable scaffold may include sintering the filler material. Forming 208 relatively porous friable filler regions in-between the dense abradable scaffold may include applying relatively porous friable filler material as a slurry formulation with pre-agglomerated or pre-aggregated particles.

Forming 208 relatively porous friable filler regions in-between the dense abradable scaffold may include producing high aspect ratio tabular particles via, for example, hydrothermal synthesis, combustion synthesis, tape casting, fine extrusion, and/or combinations thereof. Forming 208 relatively porous friable filler regions in-between the relatively dense abradable scaffold may include aligning the high aspect ratio tabular particles via, for example, electrophoretic deposition, slip casting, tape casting, extrusion, and/or combinations thereof

The method 200 may include treating 210 the abradable coating, such as the relatively dense abradable scaffold and relatively porous friable filler regions. Treating 210 the abradable coating may include treating the flowpath surface of the abradable coating formed by the relatively dense abradable scaffold and relatively porous friable filler regions to form a substantially smooth flowpath surface, such as by leveling and/or smoothing of the as-manufactured flowpath surface. Treating 210 the abradable coating may include grinding, sanding, etching or otherwise removing high areas of the flowpath surface formed by the relatively dense abradable scaffold and/or relatively porous friable filler regions. Treating 210 the flowpath surface may include an assembly grind to remove prominent portions (e.g., tips) of the relatively dense abradable scaffold (e.g., ridges) or relatively porous friable filler (e.g., valleys) to bring the flowpath surface of the abradable coating to a substantially common height so as to achieve a substantially smooth, continuous flowpath surface. Treating 210 the abradable coating may include heat treating the abradable coating which may include sintering the relatively dense abradable scaffold and/or the relatively porous friable filler regions. Heat treating 210 the abradable coating may include heating the relatively dense abradable scaffold and/or the relatively porous friable filler region to burn out, evaporate or otherwise remove fugitive materials and/or pore inducers therein via the application of heat.

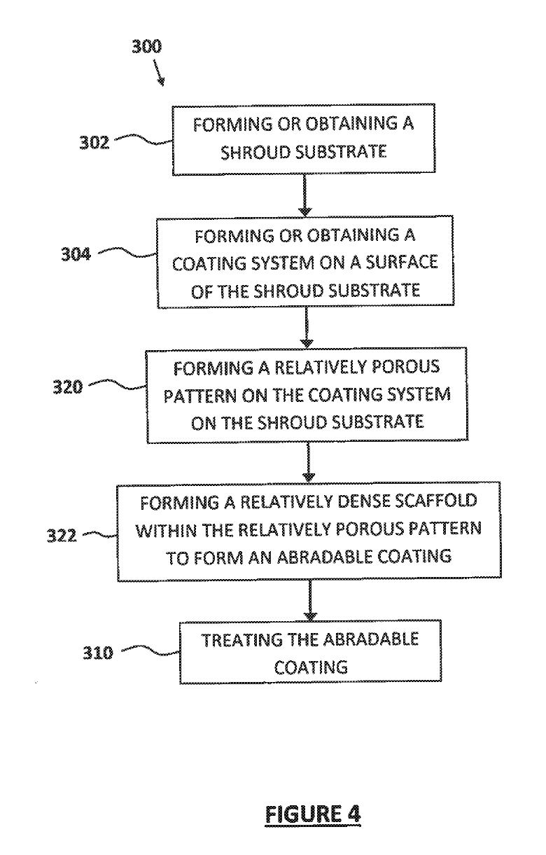

Referring to FIG. 4 a method 300 of manufacturing a shroud with an abradable coating of is similar to the method 200 of FIG. 3, and therefore like aspects are indicated by reference numerals preceded by “3” as opposed to “2.” A difference between the method 300 and the method 200 is the order of formation of the relatively porous friable and relatively dense scaffold portions of the abradable coating.

As shown in FIG. 4, the method 400 may include forming 320 a relatively porous friable pattern on the shroud substrate, such as on the coating system 20. Forming 320 a relatively porous friable pattern (the second regions 18) may include applying the relatively porous friable pattern as described above with respect to the forming 206 of a relatively dense abradable scaffold of the method 200 of FIG. 3.

The method 400 may include forming 322 a relatively dense abradable scaffold (e.g., the first regions 16 described above) in-between the relatively porous friable pattern so as to form a substantially smooth flowpath surface 30. Forming 322 a relatively dense abradable scaffold in-between the relatively porous friable pattern on the shroud substrate may include applying the relatively dense abradable scaffold on the substrate via a method or technique as described above with respect to the forming 208 relatively porous friable filler regions in-between the dense abradable scaffold of the method 200 of FIG. 3.

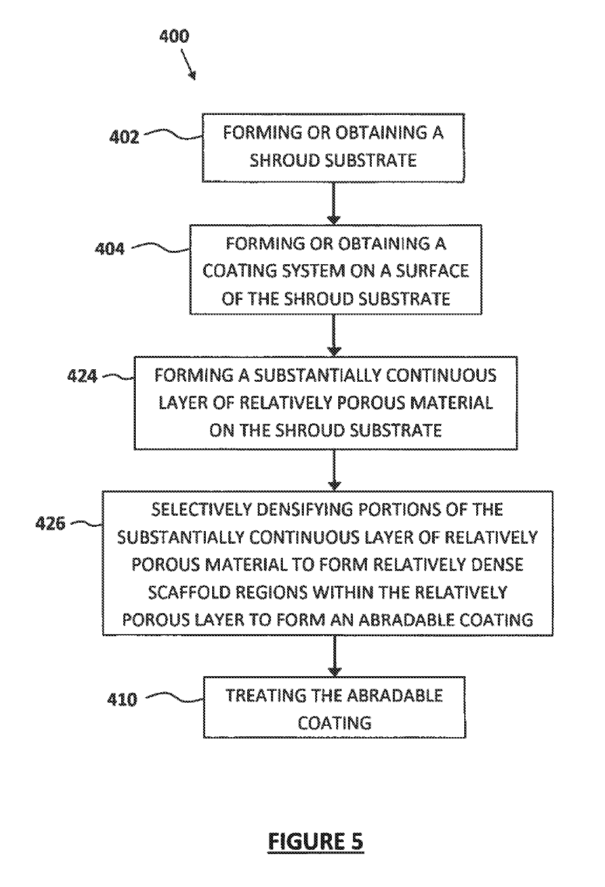

Referring to FIG. 5 a method 400 of manufacturing a shroud with an abradable coating of is similar to the methods 200 and 300 of manufacturing a shroud with an abradable coating of FIGS. 3 and 4, respectively, and therefore like aspects are indicated by reference numerals preceded by “4,” as opposed to “2” or “3.” As shown in FIG. 5, a difference between the method 400 and the methods 200 and 300 of manufacturing a shroud with an abradable coating, respectively, is the formation of the relatively porous friable filler and relatively dense scaffold regions of the abradable coating.

As shown in FIG. 5, the method 400 of manufacturing a shroud with an abradable coating may include forming 424 a substantially continuous blanket layer of relatively porous friable material on the shroud, such as on a coating system 20, so as to form a flowpath surface 30 (e.g., a layer of the material of the second regions 18 described above). Forming 424 the substantially continuous blanket layer may include utilizing relatively porous friable material as described above, for example, thermally spraying relatively porous friable material that includes fugitive materials, or utilizing slurry, paste or tape formulations having fugitive materials, or utilizing slurry, paste or tape formulations having coarse, low-sintering particles.

The method 400 may include selectively densifying 426 portions of the substantially continuous blanket layer of relatively porous friable material to form a relatively dense abradable scaffold within the layer (e.g., the first regions 16 discussed above). Selectively densifying 426 portions of the substantially continuous blanket layer of relatively porous friable material may include screen-printing or otherwise introducing sintering aids into/onto the substantially continuous blanket layer of relatively porous friable material in a scaffold pattern. The substantially continuous blanket layer of relatively porous friable material, with the scaffold pattern of screen-printed sintering aids, may be subsequently sintered to form a relatively dense abradable scaffold in the relatively porous friable layer to form the abradable coating. Selectively densifying 426 portions of the substantially continuous blanket layer of relatively porous friable material may include selectively sintering (e.g., such as using laser beam or electron-beam localized heat sources) portions of the layer in a scaffold pattern in the relatively porous friable layer so as to form the relatively dense abradable scaffold of the abradable coating.

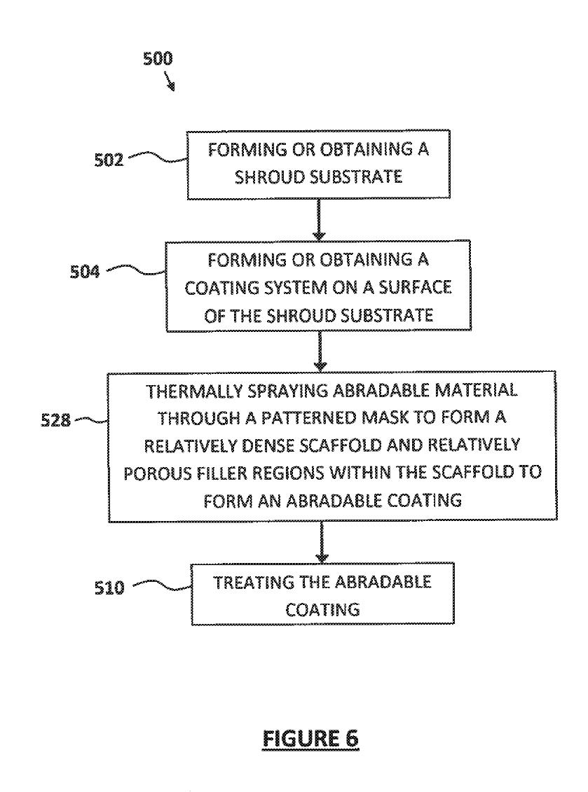

Referring to FIG. 6, a method 500 of manufacturing a shroud with an abradable coating is similar to the methods 200, 300 and 400, respectively, and therefore like aspects are indicated by reference numerals preceded by “5,” as opposed to “2,” “3” or “4.” A difference between the method 500 and the methods 200, 300 and 400, respectively, is the formation of the relatively porous friable filler and relatively dense scaffold regions of the abradable coating.

The method 500 may include thermally spraying 528 an abradable material through a patterned mask to substantially concurrently or simultaneously form a relatively dense abradable scaffold and a relatively porous friable filler. Thermally spraying 528 through the patterned mask to form a relatively dense abradable scaffold and relatively porous friable filler regions in-between the scaffold may include simultaneously forming both structures. For example, abradable materials may be thermally sprayed 528 through a patterned mask configured to produce the dense ridges or first regions 16 described above and spaced such that the second regions 18 discussed above are formed from overspray that is retained between the ridges or first regions 16. For example, the mask opening width, spacing between mask openings, gap between mask and surface being coated, thickness of the mask material, cross sectional shape of the openings, and combinations thereof may be configured to substantially contemporaneously form the relatively dense abradable scaffold and relatively porous friable filler regions in-between or within the scaffold. The mask could be configured with movable elements that adjust opening widths and/or standoff distance of the mask as the abradable coating thickness increases to more completely fill the relatively dense abradable scaffold with the relatively porous friable filler regions. An additional slurry coating of relatively porous friable filler material may subsequently be utilized to more completely fill the relatively dense abradable scaffold with the relatively porous friable filler regions.

The method 500 may include treating 510 the flowpath surface. Treating 510 the flowpath surface may include removing prominent portions of the abradable coating to a substantially uniform thickness, so as to obtain a substantially smooth flowpath surface.

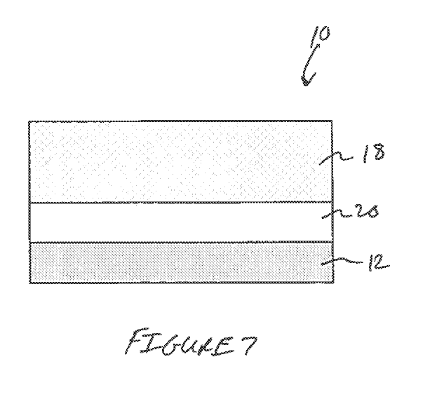

Referring to FIG. 7, an abradable coated shroud 10 may include a substrate 12, a coating system 20, and a porous, smooth abradable coating 18. The porous, smooth abradable coating 18 may be referred to as a blanket coating. The coating 18 may be formed of the material described above with respect to the second regions 18, and may be formed according to the methods also described above. The substrate 12 and the coating system 20 may also be as described above.

The coating system as disclosed herein may be, for example, as described in U.S. 2011/0052925, U.S. 2014/0037969, or U.S. application Ser. No. 14/204,367, the entire contents of each being incorporated herein by reference.

It is to be understood that the above description is intended to be illustrative, and not restrictive. For example, the above-described examples (and/or aspects thereof) may be used in combination with each other. It is to be understood that not necessarily all such objects or advantages described above may be achieved in accordance with any particular example. Thus, those skilled in the art will recognize that the systems and techniques described herein may be embodied or carried out in a manner that achieves or increases one advantage or group of advantages as taught herein without necessarily achieving other objects or advantages as may be taught or suggested herein.

This written description uses examples to describe the claimed inventions, including the best mode, and also to enable any person skilled in the art to practice the invention, including making and using any devices or systems and performing any of the methods. The patentable scope of each invention is defined by the claim.

What is claimed is:

1. A method of manufacturing a turbine shroud, comprising:
forming a porous friable coating over a barrier coating system provided on a substrate of the turbine shroud to form a substantially smooth continuous flowpath surface.

2. The method of claim 1, wherein forming the porous friable coating includes applying porous friable coating via at least one additive manufacturing method.

3. The method of claim 2, wherein the at least one additive manufacturing method comprises thermal spraying.

4. The method of claim 1, wherein the porous friable coating comprise at least one of a fugitive filler, a pore inducer, or a sintering aid.

5. The method of claim 1, wherein forming the porous friable coating includes utilizing at least one material to form the porous friable coating as a green body and sintering the green body.

6. The method of claim 1, wherein the material forming the porous friable coating comprises substantially zirconia-based or silicate-based compositions.

7. The method of claim 1, further comprising machining the porous friable coating to form the substantially continuous flowpath surface.

8. The method of claim 1, further comprising heat treating the porous friable coating.

9. The method of claim 1, wherein the porous friable coating comprises microcracks.

10. A shroud for a turbine, comprising:
a substrate having an outer surface configured to be disposed adjacent tips of rotating turbine blades and at least partially defining an outer annulus of a turbine flowpath;
a barrier coating system overlying at least a portion of the outer surface of the substrate; and
a porous friable coating overlying at least a portion of the barrier coating system, the porous friable coating defining a substantially smooth continuous flowpath surface.

11. The article of claim 10, wherein the porous friable coating comprises microcracks.

12. The article of claim 10, wherein a material forming the porous friable coating includes a sintering aid.

13. The article of claim 10, wherein the barrier coating system includes a thermal barrier coating.

14. The article of claim 13, wherein the thermal barrier coating includes stabilized zirconia.

15. The article of claim 10, wherein the barrier coating system includes an environmental barrier coating.

16. The article of claim 15, wherein the environmental barrier coating includes a rare earth silicate.

17. The article of claim 10, wherein the thickness of the porous friable coating is within a range of about 0.1 mm and about 2 mm.

18. The article of claim 10, wherein the porous friable coating includes a porosity within the range of about 20% to about 65%.
